(19) United States
(12) Patent Application Publication
(10) Pub. No.: US 2023/0032634 A1
(43) Pub. Date: Feb. 2, 2023

(54) Aggregating a dataset into a function term with the aid of transformer networks

(71) Applicant: Robert Bosch GmbH, Stuttgart (DE)

(72) Inventors: Markus Hanselmann, Stuttgart (DE); Patrick Engel, Leonberg (DE); Thilo Strauss, Ludwigsburg (DE)

(21) Appl. No.: 17/867,286

(22) Filed: Jul. 18, 2022

(30) Foreign Application Priority Data
Jul. 23, 2021 (DE) 10 2021 207 936.9

(51) Int. Cl. G06N 3/04; G06N 5/00

(52) U.S. Cl. CPC G06N 3/04; G06N 5/003

(57) ABSTRACT

A method for aggregating a dataset, which respectively assigns an output variable value to a plurality of input variable vectors, into a function term. In the method, one or more elementary function expression(s) from an alphabet is/are sampled using a neural transform network. The elementary function expressions are assembled to form one or more candidate function term(s). When the candidate function term(s) is/are complete, the input variables are mapped to associated candidate output variable values using each candidate function term. A deviation between candidate output variable values and corresponding output variable values of the dataset is evaluated using a predefined metric. It is checked whether a predefined abort condition is satisfied. If the abort condition has not been satisfied, parameters which characterize the behavior of the transformer network are updated and branching back for sampling elementary function expressions using the transformer network takes place.

### FIELD

The present invention relates to aggregating a dataset that allocates an output variable value to input variable vectors, in particular of measured data, into a function term that models the correlation included in the dataset between the input variable and the output variables.

### BACKGROUND INFORMATION

In many applications, the question arises in which way a predefined output variable of a technical system depends on a set of predefined input variables. For motors, for example, conclusive information is desired about the extent to which the torque depends on the angular velocity, the load, the slip and on additional parameters. Analytical models are available for simple applications. In more complex applications for which no analytical model exists, the input variables and output variables can be acquired in a dataset with the aid of measuring technology. Different options then exist for aggregating this dataset into a meaningful description. For example, a parameterized model is able to be fitted to the dataset by optimizing its parameters. However, it is also possible, for instance, to search a space of mathematical functions utilizing a symbolic regression in an effort to find a function that accurately describes the correlation between the input variables and the output variables.

### SUMMARY

According to the present invention, a method is provided for aggregating a dataset, which respectively assigns an output variable value yᵢ to a plurality of input variable vectors Xᵢ, i=1, . . . , N, into a function term. This ascertaining of a function term is also known as a symbolic regression. Hereinafter, the terms ‘aggregating’ and ‘symbolic regression’ are used interchangeably.

According to an example embodiment of the present invention, in the method, one or more elementary function expression(s) from a given alphabet A is/are sampled with the aid of a neural network developed as a transformer network. These elementary function expressions are assembled into one or more candidate function term(s).

A transformer network, for example, is understood in particular as a neural network in which a reciprocal dependency between all input variables in at least one layer is defined or at least tolerated. Such layers are called “attention layers”. In this way, a transformer network, for example, differs in particular from a convolutional network where preferably the input variables that have a spatial and/or temporal neighborhood relationship are offset against one another through the application of filter cores.

Sampling of function expressions, for example, particularly means that the transformer network generates a probability distribution for the individual elementary function expressions in alphabet A, and elementary function expressions are then sampled (drawn) from this probability distribution. The probability distribution may particularly be a softmax distribution in which the probabilities for all elementary function terms add up to 1.

According to an example embodiment of the present invention, it is checked whether the candidate function term(s) is/are complete. A function term is complete in particular if it is able to be evaluated by inserting concrete values for its input variables and then allocating an output variable value to these values.

In response to a not yet complete candidate function term or function terms, branching back for the sampling of further elementary function is implemented. Thus, further elementary function terms are sampled until the candidate function term(s) is/are complete. For example, it is possible to sample only an arithmetic operation (such as “+”) to begin with. Then, the two summands must also be developed through the further sampling before the function term is complete and can be evaluated.

In response to a complete candidate function term or terms 4, input variables, Xᵢ are mapped to associated candidate output values yᵢ* with the aid of each candidate function term. A deviation between candidate output variable values yᵢ* and corresponding output variable values yᵢ from the dataset are evaluated using a predefined metric.

It is checked whether a predefined abort condition is satisfied. If this is not the case, parameters θ that characterize the behavior of the transformer network are updated with the goal that the renewed sampling of function expressions and the assembling of these expressions into one or more complete candidate function term(s) will most likely improve the then obtained evaluation. Moreover, it is then branched back for the sampling of elementary function expressions with the aid of the transformer network.

The updating of parameters θ, for example, may be carried out by a backpropagation in the transformer network in any desired form, or also by reinforcement learning, for instance.

According to an example embodiment of the present invention, during the renewed sampling of elementary function expressions, it is most often the case that the development of further candidate function terms is started completely anew, that is, without the consideration of already generated candidate function terms. Optionally, however, it is possible to additionally convey to the transformer network one or more elementary function expression(s) of at least one candidate function term and their position in this candidate function term. Thus, the transformer network may build on prior experience, for instance by modifying or supplementing already used candidate function terms. However, the transformer network is not bound to such an approach and even if it receives such prior experience, it may generate a completely new candidate function term for which no relationship with the current candidate function term can be discerned.

On the other hand, if the predefined abort condition is satisfied, then a candidate function term with the best evaluation is ascertained as the desired function term, into which the dataset is aggregated. The abort condition, for example, may particularly include a threshold value or some other criterion for the evaluation of the candidate function term.

It was recognized that precisely the attention layers available in a transformer network give such a network the special ability to develop candidate function terms. The attention layers allow access to the complete candidate function term at all times.

Candidate function terms may particularly be represented in the form of expression trees. In such an expression tree, operators or functions one the hand and operands on the other hand form the nodes. The operands may particularly include variables that are populated with input variable values during the evaluation of the candidate function term, as well as constants. A node that belongs to an operator or a function has as children the particular nodes which belong to the operands that are processed by this operator or this function. Initially, for example, the development of such an expression tree may progress essentially in a depth direction before it stops and resumes at a location considerably higher in the expression tree. This requires precisely the essentially facultative access that the attention layers provide in the transformer network. In comparison, a long short-term memory, LSTM, which may basically also be used in the search for function terms, for example, is more strongly tied to the sequence in which it has sampled the elementary function expressions. For instance, if the expression tree was initially propagated into the depth, the other location where the development is to be continued at a later point may possibly have already disappeared from the time horizon provided by the LSTM of previously sampled elementary function expressions.

In one particularly advantageous example embodiment of the present invention, numerical codes are assigned to the elementary function expressions from the alphabet and also to their positions in the candidate function term. At least one candidate function term is converted into a representation formed from these numerical codes. This representation is conveyed to the transformer network during the sampling in order to be able to develop the candidate function term also in a step-by-step manner. This enables the transformer network to correctly interpret even very deep tree structures semantically and to understand which form element satisfies which particular function at which particular location in the tree in each case. For instance, the numerical codes relating to the elementary function expressions may be merged through summing or concatenating with the numerical codes that relate to the positions in the candidate function term. Prior to the merging, the numerical codes relating to the elementary function expressions are able to be preprocessed, for instance by an embedding layer. With the aid of such an embedding layer, numerical codes are particularly able to be mapped (embedded) in a vector space having a predefined dimension. The numerical codes relating to the positions in the candidate function term are likewise able to be preprocessed by positional encoding before they are merged with the numerical codes for the elementary function terms. After the positional encoding, the numerical codes can particularly encode the position of the respective elementary function term in an expression tree, for example.

In a particularly advantageous manner, the numerical codes thus indicate the positions of the elementary function expressions in the mentioned semantic expression tree.

There are different possibilities for specifying the numerical codes within the semantic expression tree. In an especially advantageous manner, numerical codes are also assigned to non-populated positions in the tree. For example, this may particularly mean that the tree is initially developed down to a predefined maximally possible depth, where each node branches to a predefined number of children during the change from one level to the next. A position may then remain unpopulated, for instance, if a node has two or more children at the next-deepest layer but is populated by a function that expects only a single argument (e.g., sine or cosine). The numerical code of each node depends only on the position of this node in the tree rather than some other content of the tree.

In contrast, if the nodes are consecutively numbered, then only a maximum length of the candidate function term but no maximum depth of the tree must be specified. In return, it will then be more difficult for the transformer network to understand the tree structure.

In a further advantageous example embodiment of the present invention, the numerical codes include vectors that have separate components for the levels of the tree in each case. Thus, if the tree thus has a depth of three, for instance, then the vector has three components. Each component assigned to a level then indicates a direction in which branching took place on the path from the root of the tree to the nodes in the transition to the respective level. For example, if branching to the left of a root node with a numerical code (0, 0, 0) took place to the second level, then this node may receive the numerical code (0, −1, 0), and if branching to the right occurs to the second level, then this node may receive the numerical code (0, 1, 0). In this scheme, neighborhood relationships of nodes are particularly easy to detect for the transformer network. The maximum depth of the tree has to be predefined. If—as in this example—the first component is always 0, then it may optionally also be omitted. A node of a tree having the maximum depth N may thus be represented by an N−1-dimensional vector.

In one particularly advantageous embodiment of the present invention, parameters θ which characterize the behavior of the transformer network are optimized with the goal of improving an evaluation averaged across a plurality or distribution of candidate function terms. Reinforcement learning, in particular, may be used to achieve a progressive improvement despite the non-deterministic character of the sampling.

If it is assumed, for instance, that τ is a candidate function term and Xᵢ is a vector of input variables (x₁, . . . , xⱼ), then it will be possible to ascertain a fitness ξ of this candidate function term τ, for example via an average square deviation of the output variable values τ(xᵢ) ascertained using the candidate function term from the predefined output variable values yᵢ:

$$ξ = \frac{1}{{σ}_{y}} \sqrt{\frac{1}{N} {\sum }_{i = 1}^{N} {( τ ( {x}_{i} ) - {y}_{i} )}^{2} ,}$$

where σ_{y} indicates the standard deviation of output variable values yᵢ. From fitness ξ, a reward R(τ) is able to be defined via

$$R ( τ ) = \frac{1}{1 + ξ} .$$

The goal of reinforcement learning is an optimization of parameters θ of the transformer network in such a way that the expected value

J(θ)= [symbol] _{τ˜p(τ|θ)}[R(τ)]

is maximized via the distribution p(τ|θ) of candidate function terms τ at a given status of parameters θ. For instance, this may be realized via a gradient ascent method

∇_{θ}J(θ)=∇_{θ} [symbol] _{τ˜p(τ|θ)}[R(τ)]= [symbol] _{τ˜p(τ|θ)}[R(τ)∇_{θ}log p(τ|θ)].

Since this term is usually unable to be determined analytically, it is possible as an alternative to use an unbiased estimator

$${∇}_{θ} J ( θ ) \approx \frac{1}{M} {\sum }_{k = 1}^{M} R ( {τ}^{( k )} ) {∇}_{θ} log p ( τ \vert θ )$$

for the expected value.

For the symbolic regression, this means that a number of M function terms is sampled by the transformer network using parameters θ. To the extent that these function terms also include constants, they can be optimized with the aid of a constant optimizer. The reward for the terms will then be determined and the gradient is estimated as described in order to update the parameters of the transformer network so that the expected reward is maximized over time. As an alternative or also in combination therewith, for example, a further layer is able to be added to the transformer network with whose aid constants are able to be sampled.

However, the ultimate goal does not consist of increasing the expected value for the reward for all function terms. Instead, it is of interest that the best function term has a high reward. In a further, particularly advantageous embodiment of the present invention, only deviations that stem from a selection of best-evaluated candidate function terms are therefore utilized for updating the parameters. For example, it is possible to specify a threshold value R_{ε}(θ) for the reward and to maximize the term

J(θ;ε)= [symbol] _{τ˜p(τ|θ)}[R(τ)|R(τ)≥R_{ε}(θ)]
which may be realized via a gradient estimation via

$${∇}_{θ} J ( θ ; ε ) \approx \frac{1}{N ε} {\sum }_{k = 1}^{N} ( R ( {τ}^{( k )} ) - {R}_{ε} ( θ ) ) \cdot 1 [ R ( {τ}^{( k )} ) \geq {R}_{ε} ( θ ) ] {∇}_{θ} log p ( τ \vert θ )$$

Herein, 1 is the indicator function.

For example, a corresponding generic formalism is provided by Petersen et al. in, “Deep symbolic regression: Recovering mathematical expressions from data via risk-seeking policy gradients”, arXiv: 1912.04871.

When training the transformer network, regularization terms, e.g., an entropy loss, may be used to achieve a higher variance in the terms.

As described above, input variable vectors Xᵢ, and/or output variable values yᵢ, may particularly include measured data that were recorded with the aid of at least one sensor. For example, in particular a large volume of measured data recorded with a high resolution is able to be aggregated into a compact function term. Apart from a mere volume aggregation, this also makes it possible to obtain a better qualitive understanding of the behavior of the output variable as a function of the input variables. For instance, the known laws of gravity may be derived from the results of drop tests in a drop tower.

In a further, particularly advantageous embodiment of the present invention, output variable yᵢ is a measured variable of a first sensor, and the input variable vectors include measured variables of further sensors from which the measured variable of the first sensor can be ascertained at least as an approximation. If it is possible to model the dependency of the measured variable of the first sensor on the measured variables of the further sensors in a satisfactory manner, it will also be possible to omit this first sensor. For instance, a pre-series model in the device development may include all sensors, and on the path to a series model, sensors whose measured variables are also easily derivable from the measured variables of other sensors may successively be omitted. The savings in hardware costs are then multiplied by the number of units of the series production.

In general, the function term ascertained by the method may be utilized to subsequently evaluate further measured data. This is advantageous especially for the data evaluation in a control unit for a vehicle which usually has only limited hardware resources. For this reason, in a further, particularly advantageous embodiment, measured data that were recorded using at least one sensor are mapped as components of input variable vectors with the ascertained function term to output variable values. These output variable values are used to generate an actuation signal. A vehicle is actuated by this actuation signal.

In a further particularly advantageous embodiment of the present invention, alphabet A of the available elementary function expressions is restricted to operators and/or functions that are available on a predefined embedded platform for the evaluation of the ascertained function term. The predefined embedded platform is then set up for the evaluation of the ascertained function term, for instance by loading a corresponding software or some other program. For instance, embedded platforms that are especially energy-efficient at the expense of restricting the available instruction set are available on the market. For example, there are platforms on which only the four basic arithmetic operations are available, and logarithms can be called up from tables, but no exponential function and no trigonometric functions are able to be calculated. The method then supplies the particular function term that approximates the relationship between the input variables and the output variables as best as possible under the marginal condition of the restricted alphabet A.

In a further particularly advantageous embodiment of the present invention, the elementary function expressions of at least one best-evaluated candidate function term as well as their positions in this best-evaluated candidate function term in multiple epochs are conveyed to the transformer network. By storing the best experience in such a way in an epoch-spanning manner, the transformer network is given an even greater incentive for sampling good function terms. This is comparable to the experience replay in reinforcement learning. In this context, it is optionally possible to modify a portion of the reloaded function terms by exchanging old elementary function expressions for newly sampled ones or by expanding the function term by newly sampled elementary function expressions. An exploration may be carried out on this basis with the goal of finding even better function terms.

Sampled function terms may also have simplification potential. For example, the two function terms sin(x+x−x) and sin(x) are identical, but the latter term is simpler and thus should preferably be selected. It is therefore advantageous to propagate not only the candidate function terms but also possible simplifications of these candidate function terms through the transformer network. They may then be treated exactly like other terms in the transformer network. This teaches the transformer network to prefer simple terms.

To achieve higher variability in the function terms and to prevent that the optimization of the parameters of the transformer network leads to a local extreme, it is possible, for instance, to sample elementary function expressions for a certain percentage from a predefined distribution, e.g., an equal distribution, across all elementary function expressions in alphabet A. This percentage can be adapted during the optimization. For example, if the reward on average does not improve across multiple epochs, then the percentage is able to be increased. This increases the chance of jumping out of a local extreme. If the reward improves, on the other hand, the percentage is able to be reduced because the network training obviously seems to go in the right direction.

The method may be computer-implemented, especially in its entirety or in part. The present invention therefore also relates to a computer program including machine-readable instructions that when executed on a computer or on a plurality of computers, induce the computer(s) to execute the described method. In this sense, control units for vehicles and embedded systems for technical systems that are likewise capable of carrying out machine-readable instructions should also be considered computers.

In the same way, the present invention also relates to a machine-readable data carrier and/or to a download product including the computer program. A download product is a digital product that is transmittable via a data network, i.e., a digital product able to be downloaded by a user of the data network, which may be offered for sale in an online shop for an immediate download, for example.

In addition, a computer may be equipped with the computer program, the machine-readable data carrier and/or the download product.

Additional measures improving the present invention will be represented in greater detail in the following text together with the description of the preferred exemplary embodiments with the aid of figures.

### BRIEF DESCRIPTION OF THE DRAWINGS

FIG. 1 shows an exemplary embodiment of method 100 for aggregating a dataset 1, according to the present invention.

FIG. 2 shows an exemplary structure of a transformer network 1 for use in method 100, according to the present invention.

FIGS. 3A-3C show exemplary encodings of positions 3a #-3 d # in candidate function term 4 in numerical codes 7a-7d, according to the present invention.

### DETAILED DESCRIPTION OF EXAMPLE EMBODIMENTS

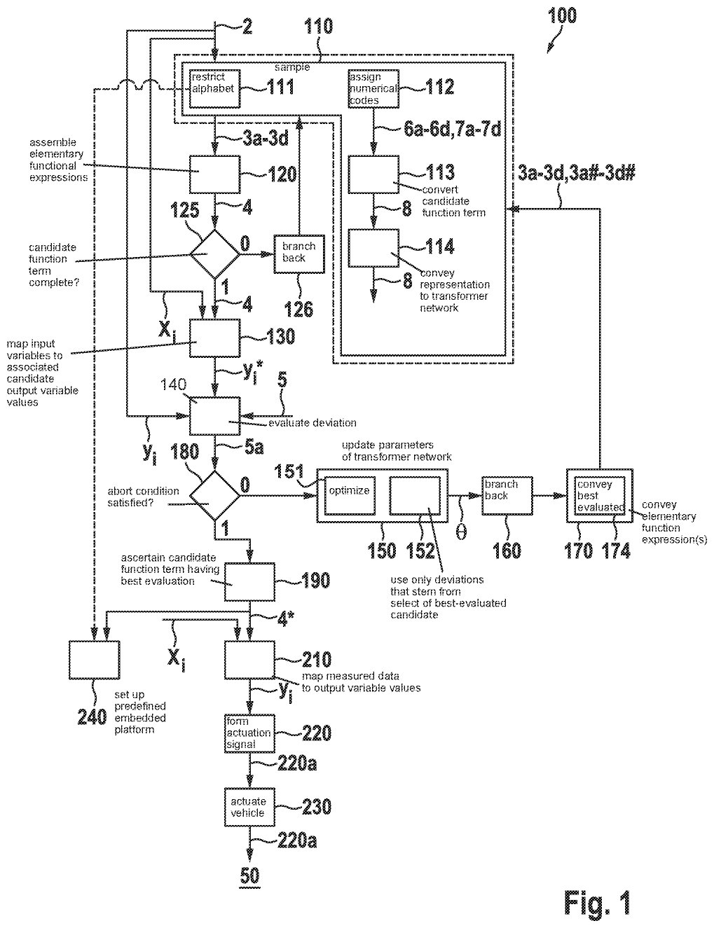

FIG. 1 is a schematic flow diagram of an exemplary embodiment of method 100 for aggregating a dataset 2, which respectively assigns an output variable value yᵢ to a multitude of input variable vectors Xᵢ, i=1, . . . , N, into a function term 4*.

In step 110, a function expression or a plurality of function expressions from an alphabet A is/are sampled with the aid of transformer network 1.

In the process, alphabet A according to block 111 is able to be restricted to operators or functions that are available on a predefined embedded platform for the evaluation of ascertained function term 4*.

In step 120, these elementary function expressions 3a-3d are assembled to form one or more candidate function term(s) 4.

According to block 112, numerical codes 6a-6d; 7a-7d are able to be assigned to elementary function expressions 3a-3d from alphabet A as well as their positions 3a #-3d # in candidate function term 4 in each case. According to block 113, at least one candidate function term 4 is then able to be converted into a representation 8 formed from these numerical codes 6a-6d; 7a-7d. According to block 114, this representation 8 may then be conveyed to transformer network 1 during sampling 110 in order to be able to develop candidate function term 4 also in multiple steps of the sampling.

In step 125, it is checked whether the candidate function term(s) 4 is/are complete. If this is not the case (truth value 0), branching back for the sampling 110 of further elementary function expressions then takes place in step 126.

However, if the candidate function term(s) 4 is/are complete (truth value 1), input variables Xᵢ are mapped in step 130 to associated candidate output variable values yᵢ* with the aid of each candidate function term 4.

In step 140, a deviation between candidate output variable values yᵢ* and corresponding output variable values yᵢ from dataset 2 are evaluated using a predefined metric 5.

In step 180, it is checked whether a predefined abort condition is satisfied. If this is not the case,
parameters θ that characterize the behavior of transformer network 1 are updated in step 150 with the goal that the renewed sampling of function expressions 3a-3d and the assembly of these expressions to form one or more complete candidate function term(s) (4) most likely improves the evaluation 5a then obtained, and
branching back to sampling 110 of elementary function expressions 3a-3d using transformer network 1 takes place in step 160.

In the process, according to block 151, parameters θ which characterizes the behavior of transformer network 1 can be optimized with the goal of improving an evaluation 5a averaged across a plurality or distribution of candidate function terms 4.

According to block 152, only deviations that stem from a selection of best-evaluated candidate function terms 4 may be used for updating parameters θ.

Optionally, in step 170, one or more elementary function expression(s) 3a-3d of at least one candidate function term 4 and its/their position(s) 3a #-3d # in this candidate function term 4 may additionally be conveyed to transformer network 1. In the process, for instance, especially the elementary function expressions 3a-3d and also their positions 3a #-3d # are able to be encoded by numerical codes 6a-6d; 7a-7d in the same way as in the original preparation of the complete candidate function term.

According to block 174, elementary function expressions 3a-3d of at least one best-evaluated candidate function term 4 and their positions 3a #-3d # in this best-evaluated candidate function term 4 in a plurality of optimization epochs may be conveyed to transformer network 1.

On the other hand, if the abort condition is satisfied (truth value 1 in step 180), then a candidate function term 4 having the best evaluation 5a is ascertained as the desired function term 4* in step 190 into which dataset 2 is aggregated. If there is a selection from among a plurality of candidate function terms 4 of different complexity, then in particular a less complex candidate function term 4 may be given priority.

In step 210, measured data that were recorded using at least one sensor are mapped as components of input variable vectors Xᵢ with the ascertained function term 4* to output variable values yᵢ.

In step 220, an actuation signal 220a is formed from these output variable values yᵢ.

In step 230, a vehicle 50 is actuated with the aid of this actuation signal 220a.

If alphabet A was restricted to the operators or functions available on a predefined embedded platform according to block 111, then this predefined embedded platform is set up in step 240 for the evaluation of ascertained function term 4*.

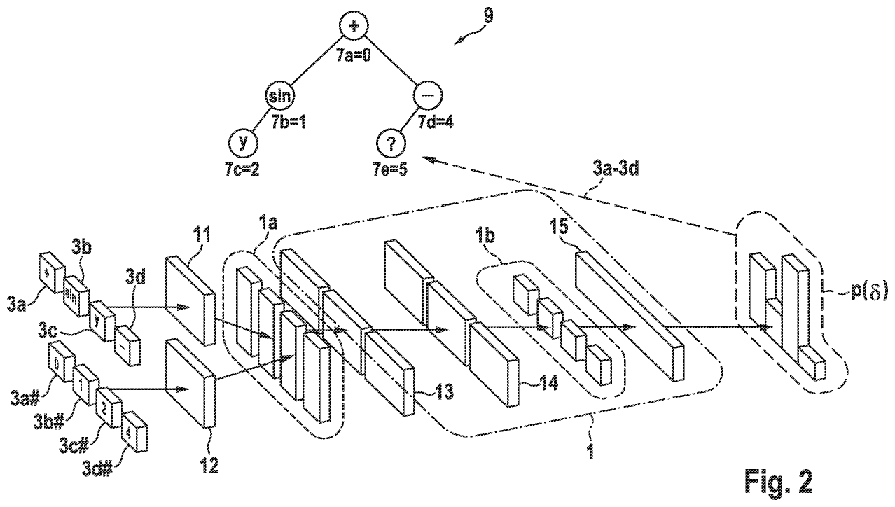

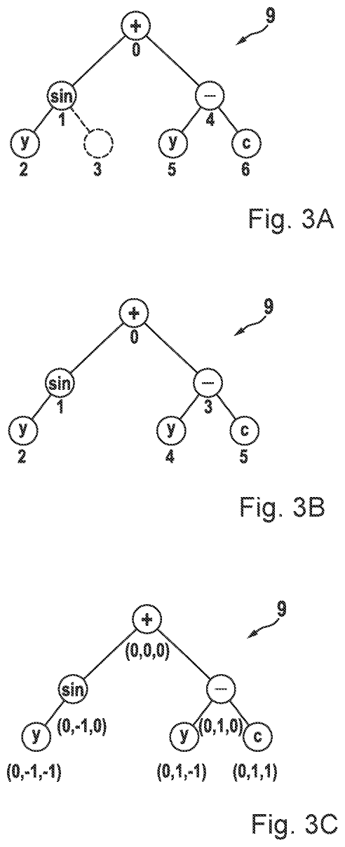

FIG. 2 illustrates an exemplary structure of a transformer network 1 and its use for sampling elementary function expressions 3a-3d. In the snapshot shown in FIG. 2, function term sin(y)+− was already generated, but it is not yet complete. At present, a search for a first operand for the minus sign is carried out. The function term is shown in an expression tree 9, and positions 3a #-3d # of the individual elementary function expressions 3a-3d are provided with numerical codes 7a-7d in each case. The creation of these numerical codes 7a-7d will be described in greater detail in FIGS. 3A-3C.

Via preprocessing layers 11 and/or 12, elementary function expressions 3a-3d as well as their positions 3a #-3d #, and/or their numerical codes 6a-6d, 7a-7d are processed into an input 1a for transformer network 1. Transformer network 1 includes two multi-head attention layers 13 and 14, which generate an output 1b. This output 1b is combined in an averaging layer 15 and processed into a softmax probability distribution p(δ) for elementary function expressions 6. The next elementary function expression 3a-3d to be added to the function term is drawn from this probability distribution p(δ). This elementary function expression is assigned the position 7e with numerical code 5 in expression tree 9.

FIGS. 3A-3C shows three different ways in which the numerical codes 7a-7d for positions 3a #-3d # of elementary function expressions 3a-3d are able to be assigned for the representation of function term sin(y)+y−c in an expression tree 9.

According to FIG. 3A, except for the particular nodes in the previously specified deepest layer, it is assumed that all nodes have two children. However, the node sketched in the form of dashes is not populated because the sine function expects only one argument. Nevertheless, this non-populated node is counted too. In this example, numerical code 7a-7d for position 3a #-3d # depends only on the position of the node (“pre-order traversal”).

In contrast, in FIG. 3B, only the populated nodes are consecutively numbered (“progressive”). Here, the maximum depth of tree 9 need not be specified. In return, numerical code 7a-7d is less meaningful with regard to the semantics of the function term.

According to FIG. 3C, the direction in which branching took place on the path from the root of the tree to the node in the transition to the respective level is indicated for each node. Thus, the root of the tree has the vector (0, 0, 0) as the numerical code, and the first component of all other vectors is also 0 because the root of the tree was created without branching.

All nodes that are obtained by branching to the left from the root are given the direction −1 in the second component of their numerical code. All nodes that are obtained by branching to the right of the root receive the direction 1 in the second component of their numerical code. For the nodes at the second level of the tree, the third component is still 0 because the third level has not yet been reached.

In an analogous manner, branching to the left in the transition from the second to the third level of the tree leads to an entry −1, and branching to the right leads to an entry 1 in the third component of the numerical code.

1-16. (canceled)

17. A method for aggregating a dataset, which respectively assigns an output variable value to a plurality of input variable vectors, into a function term, the method including the following steps:
sampling one or a plurality of elementary function expressions from a given alphabet using a neural network, the neural network being a transformer network;
assembling the one or plurality of elementary function expressions to form one or more candidate function terms;
checking whether the one or more candidate function terms is complete;
based on the one or more candidate function terms being not yet complete, branching back for sampling further elementary function expressions;
based on the one or more candidate function terms being complete, respectively mapping the input variable vectors onto associated candidate output variable values using each of the one or more candidate function terms;
evaluating a deviation between the associated candidate output variable values and corresponding output variable values from the dataset using a predefined metric;
checking whether a predefined abort condition is satisfied;
based on the abort condition not being satisfied:
updating parameters that characterize a behavior of the transformer network with a goal that a renewed sampling of function expressions and assembling of the renewed sampled expressions to form one or more complete candidate function terms will likely improve the evaluation then obtained, and
branching back to the sampling of elementary function expressions using the transformer network; and
based on the predefined abort condition being satisfied, ascertaining a candidate function term of the one or more candidate function terms having the best evaluation as a desired function term into which the dataset is aggregated.

18. The method as recited in claim 17, wherein one or more elementary function expressions of at least one candidate function term and its/their positions in the candidate function term is/are additionally conveyed to the transformer network.

19. The method as recited in claim 17, wherein:
numerical codes are respectively assigned to the elementary function expressions from the alphabet, and their positions in the candidate function term,
at least one candidate function term is converted into a representation formed from the numerical codes; and
the representation is supplied to the transformer network.

20. The method as recited in claim 19, wherein the numerical codes for the positions of elementary function expressions in the candidate function term indicate positions of the elementary function expressions in a semantic expression tree of the candidate function term, in which:
operators or functions on the one hand and operands on the other hand form the nodes, and
a node which belongs to an operator or a function has as children the nodes that belong to the operands that are processed by the operator or this function.

21. The method as recited in claim 20, wherein numerical codes are assigned also to non-occupied positions in the tree.

22. The method as recited in claim 20, wherein the numerical codes include vectors that respectively have separate components for levels of the tree, and each component assigned to a level indicates a direction in which branching took place on a path from a root of the tree to the node in a transition to the respective level.

23. The method as recited in claim 17, wherein the parameters that characterize the behavior of the transformer network are optimized toward a goal of improving an evaluation averaged across a plurality or distribution of candidate function terms.

24. The method as recited in claim 17, wherein only deviations that stem from a selection of best-evaluated candidate function terms are used for updating the parameters.

25. The method as recited in claim 17, wherein the input variable vectors and/or the output variable values, include measured data that were recorded using at least one sensor.

26. The method as recited in claim 25, wherein the output variable is a measured variable of a first sensor, and the input variable vectors include measured variables of further sensors from which the measured variable of the first sensor is ascertainable at least as an approximation.

27. The method as recited in claim 17, wherein:
measured data that were recorded using at least one sensor are mapped as components of the input variable vectors, using the ascertained function term, to output variable values;
an actuation signal is formed from the output variable values; and
a vehicle is actuated using the actuation signal.

28. The method as recited in claim 17, wherein:
the alphabet is restricted to operators or functions that are available on a predefined embedded platform for the evaluation of the ascertained function term, and
the predefined embedded platform is set up for the evaluation of the ascertained function term.

29. The method as recited in claim 23, wherein the elementary function expressions of at least one best-evaluated candidate function term and their positions in the best-evaluated candidate function term in multiple epochs of the optimization are supplied to the transformer network.

30. A non-transitory machine-readable data carrier on which is stored a computer program including machine-readable instructions for aggregating a dataset, which respectively assigns an output variable value to a plurality of input variable vectors, into a function term, the instructions, when executed by a computer, causing the computer to perform the following steps:
sampling one or a plurality of elementary function expressions from a given alphabet using a neural network, the neural network being a transformer network;
assembling the one or plurality of elementary function expressions to form one or more candidate function terms;
checking whether the one or more candidate function terms is complete;
based on the one or more candidate function terms being not yet complete, branching back for sampling further elementary function expressions;
based on the one or more candidate function terms being complete, respectively mapping the input variable vectors onto associated candidate output variable values using each of the one or more candidate function terms;
evaluating a deviation between the associated candidate output variable values and corresponding output variable values from the dataset using a predefined metric;
checking whether a predefined abort condition is satisfied;
based on the abort condition not being satisfied:
updating parameters that characterize a behavior of the transformer network with a goal that a renewed sampling of function expressions and assembling of the renewed sampled expressions to form one or more complete candidate function terms will likely improve the evaluation then obtained, and
branching back to the sampling of elementary function expressions using the transformer network; and
based on the predefined abort condition being satisfied, ascertaining a candidate function term of the one or more candidate function terms having the best evaluation as a desired function term into which the dataset is aggregated.

31. One or more computers configured to aggregate a dataset, which respectively assigns an output variable value to a plurality of input variable vectors, into a function term, the one or more computers configured to:
sample one or a plurality of elementary function expressions from a given alphabet using a neural network, the neural network being a transformer network;
assemble the one or plurality of elementary function expressions to form one or more candidate function terms;
check whether the one or more candidate function terms is complete;
based on the one or more candidate function terms being not yet complete, branch back for sampling further elementary function expressions;
based on the one or more candidate function terms being complete, respectively map the input variable vectors onto associated candidate output variable values using each of the one or more candidate function terms;
evaluate a deviation between the associated candidate output variable values and corresponding output variable values from the dataset using a predefined metric;
check whether a predefined abort condition is satisfied;
based on the abort condition not being satisfied:
update parameters that characterize a behavior of the transformer network with a goal that a renewed sampling of function expressions and assembling of the renewed sampled expressions to form one or more complete candidate function terms will likely improve the evaluation then obtained, and
branch back to the sampling of elementary function expressions using the transformer network; and
based on the predefined abort condition being satisfied, ascertain a candidate function term of the one or more candidate function terms having the best evaluation as a desired function term into which the dataset is aggregated.
